(19) United States
(12) Patent Application Publication
(10) Pub. No.: US 2010/0089106 A1
(43) Pub. Date: Apr. 15, 2010

(54) Secure slide bolt with integrated lock

(76) Inventor: Robert C. Bowers, II, Allentown, PA (US)

Correspondence Address: SANFORD J. PILTCH, ESQ., 1132 HAMILTON STREET, SUITE 201, ALLENTOWN, PA, 18101, US

(21) Appl. No.: 12/287,540

(22) Filed: Oct. 10, 2008

(51) Int. Cl. E05C 1/06

(52) U.S. Cl. 70/129; 292/138

(57) ABSTRACT

The invention relates to a secure slide bolt device, and can be utilized in a number of different structures and on different structures access points. More specifically the invention relates to a slide bolt having a locking mechanism integral with and part of the slide bolt. The invention is designed specifically so that the locking mechanism locks into the slide bolt, rather than being a separate and distinct mechanical lock.

### BACKGROUND OF THE INVENTION

The invention relates to a unique locking device and particularly to an exterior slide bolt type-locking device for securing doors and gates. More particularly, the invention relates to a slide bolt type lock in which the locking mechanism is integrated into the slide bolt.

Conventional slide bolt locks are widely know and used to lock structures such as gates, entry doors and overhead doors. It is well known for conventional slide bolt designs to use a separate padlock or other non-integrated locking system. The present locking device is structured to mechanically integrate with the slide bolt to lock and unlock the protected entryway.

Several patents are illustrative of earlier, similar devices. U.S. Pat. No. 4,095,828 [East] describes a slide lock, including barrel and bolt members, for securing a gate or similar structure. The shackle of the padlock is inserted into and around a first aperture in the bolt extension and then through a second aperture in both the bolt extension and the barrel to secure the bolt in the closed position. The barrel has longitudinal extensions that limit tampering with the bolt and lock when the bolt is engaged by folding over the outer surfaces of the barrel and the shackles of the padlock when inserted in the locking mechanism. Unlike the current invention the padlock shackles are not locked directly into and through the slide bolt and barrel housing.

U.S. Pat. No. 4,234,220 [Finch, et al.] discloses a tamper proof exterior locking system that includes dual sets of shackles for securing padlocks to the slide bolt assembly. An external housing extending outward from the back plate extends over and around the padlocks when inserted onto the shackles, preventing tampering. Both padlocks are engaged regardless of the position of the slide bolt, i.e., engaged or disengaged. The differences from the described invention are that one set of shackles is fixedly mounted to the back plate and the second set is insertable into and through the cover plate when the slide bolt is positioned. Again, this patent does not disclose the shackles of the padlock directly connected to the slide bolt.

The present invention will allow the locking mechanism to include the slide bolt as an integral part of the locking device, and not as a separately combined apparatus. None of the patents discussed above provide for the integration of the actual locking apparatus onto or through the shaft of the slide bolt, or though the barrel housing, nor do they provide for the disengaged locking of the slide bolt device.

It is an object of the present invention to provide a single locking device that can be locked in either the engaged or disengaged position using an integrated locking apparatus. It is a further object of the present invention to provide a slide bolt locking device that has an integral key-way or combination lock integrally mounted to the shaft of the slide bolt so that the locking mechanism is always attached to the locking device whether in the engaged or disengaged position.

It is an additional object of the present invention to permit the locking of the slide bolt locking device in both the engaged and in the disengaged position to prevent tampering with the locking device. It is yet another object of the present invention to substantially eliminate tampering with the slide bolt locking device, whether engaged or disengaged, by integrally mounting the locking apparatus to and through the shaft of the slide bolt and through the barrel housing.

Other objects will appear hereinafter.

### SUMMARY OF THE INVENTION

The present slide bolt locking device invention comprises an entryway locking apparatus including a slide bolt with an integrated key or combination lock. The locking device has a body and a shaft movable into and out of engagement with a slide bolt keeper. The invention further comprises a means for attaching the barrel housing and the slide bolt keeper to a structure such as a door or other entryway closing apparatus such as a gate. The locking device has a locking mechanism with means to engage and disengage directly onto the shaft while the shaft is engaged with the slide bolt keeper, and also while the shaft is disengaged from the slide bolt keeper. Two apertures in the barrel housing for the slide bolt are provided to accommodate the means for locking mechanism to engage and disengage directly onto or through the slide bolt shaft. The invention may also be accomplished by a single aperture in the shaft to accommodate the means for locking mechanism to engage and disengage directly onto said shaft.

### BRIEF DESCRIPTION OF THE DRAWINGS

FIG. 1 is a front view of the locking device of the present invention showing the locking mechanism engaged.

FIG. 2 is a front view of the locking device of the present invention showing the locking mechanism disengaged.

FIG. 3 is a front view of the locking device of the present invention showing the locking mechanism disengaged and swung outward for withdrawing the bolt from the keeper.

FIG. 4 is a front view of the locking device of the present invention showing the locking mechanism disengaged, swung outward, and being re-aligned with the disengaged bolt locking position.

FIG. 5 is a front view of the locking device of the present invention showing the locking mechanism disengaged, swung inward, and being re-aligned with the disengaged bolt locking position.

FIG. 6 is a front view of the locking device of the present invention showing the locking mechanism re-engaged in the disengaged bolt locking position.

FIG. 7 is a view of a structure entry door showing the locking device of the present invention mounted to the entry door.

FIG. 8 is a view of a fence and gate system showing the locking device of the present invention mounted to the gate and adjoining fence structure.

FIG. 9 is a view of an overhead door system showing a pair of the locking devices of the present invention mounted to the door at two points and the opposing door rail structure.

### DETAILED DESCRIPTION OF THE INVENTION

The principles and operation of the present invention are better understood with reference to the drawings and the accompanying description. The description is not intended in a limiting sense, and is made solely for the purpose of illustrating the general principles of the invention. The various features and advantages of the present invention may be more readily understood with reference to the following detailed description taken in conjunction with the accompanying drawings. In order to aid in understanding of the invention, reference numerals that are referred to in the specification with respect to one or more figures may appear in additional figures without a specific reference to such additional figures in the specification.

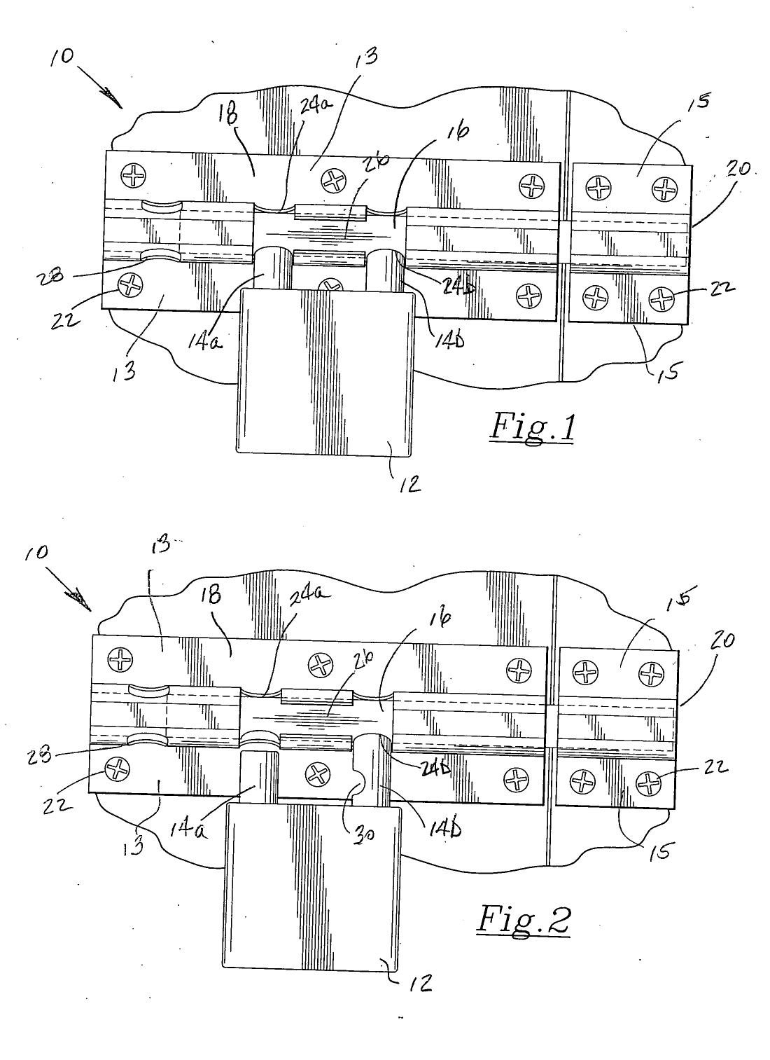

The following detailed description is of the best presently contemplated modes of carrying out the invention. Referring now to the drawings in detail, there is shown in FIG. 1 one form of the locking device 10 of the present invention. The locking device 10 can be made of any well-known lock material, such as metals and metal alloys, and is comprised of a lock body 12, locking pins 14a, 14b, and a slide bolt 16 slidably mounted within barrel housing 18 to enable the mounting of the locking device 10 to a structure. The slide bolt or movable shaft 16 is housed within the barrel housing 18 and is movable into and out of a slide bolt keeper 20 also having means to enable the mounting of the keeper 20 to the structure. Both the barrel housing 18 and slide bolt keeper 20 have means to mount these elements to structures, i.e., flanges 13, 15, to facilitate the mounting of each of each to a structure through a series of apertures in the flanges 13, 15. Attachment of the locking device 10 to a structure can be accomplished using any known fastening means to mount the flanges 13, 15 of the barrel housing 18 and slide bolt keeper 20 to the structure. In the drawings the fastening means 22 are shown as screws.

The locking 12 of the invention is comprised a locking mechanism (not shown) internal to the lock, two locking pins 14a, 14b that extend upward out of the body of the lock 12, extending toward the slide bolt 16. Locking pin 14a fits into a cooperating and appropriately sized aperture 24a in movable shaft 16 when the lock 12 is in the engaged or locked position. Locking pin 14b is integrally attached and made part of the slide bolt 16 at an aperture 24b into which the locking pin 14b is permanently fixed. An H-shaped aperture 26 in the barrel housing 18 spans the space between and includes the aperture 24a and the attachment point 24b to facilitate the sliding movement of movable shaft 16 and locking means 12 back and forth within the barrel housing 18. A second aperture 28 in barrel housing 18, having similar dimensions to aperture 24a, facilitates the securing of the locking means 12 while movable shaft 16 is disengaged from the slide bolt keeper 20 to be more fully described below.

Referring to FIG. 2, locking means 12 is shown in an unlocked position exposing a notch 30 in locking pin 14b, which facilitates locking of the locking mechanism in lock 12. Locking pin 14b may be welded or permanently attached by any other well-known method to the movable shaft 18. When the locking mechanism 12 is in the unlocked position, rotational movement of the slide bolt 16 along the longitudinal axis within the barrel housing 18 and lateral movement of the slide bolt 16 and attached locking device 12 through the H-shaped aperture 26 will permit the withdrawal of the slide bolt 16 from the keeper 20. FIG. 2 also shows the locking pin 14a in the unlocked position withdrawn from the locking aperture 24a within barrel housing 18. Locking pin 14a may be attached permanently to locking means 12 with an outward length sufficient to fully engage the locking aperture 24a, but not overly long to block the rotation of the slide bolt 16 within the barrel housing 18 in order to permit disengagement of the locking pin 14a from the slide bolt 16 and facilitate lateral movement of the slide bolt 16.

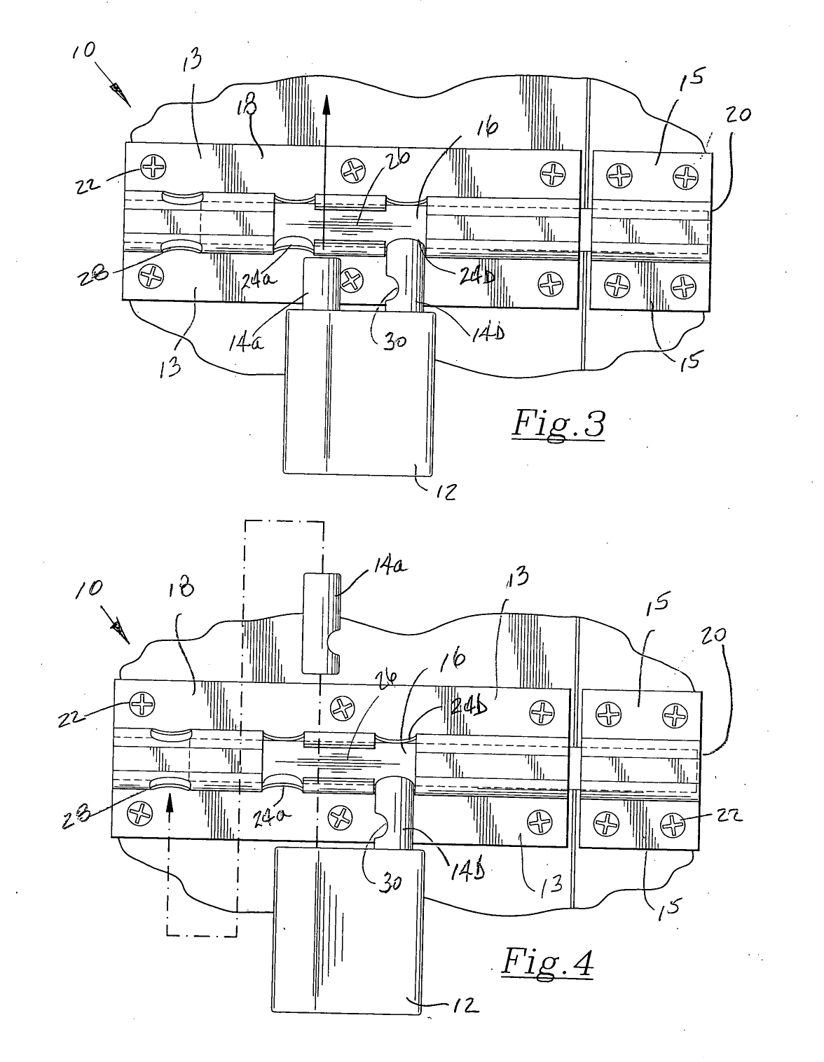

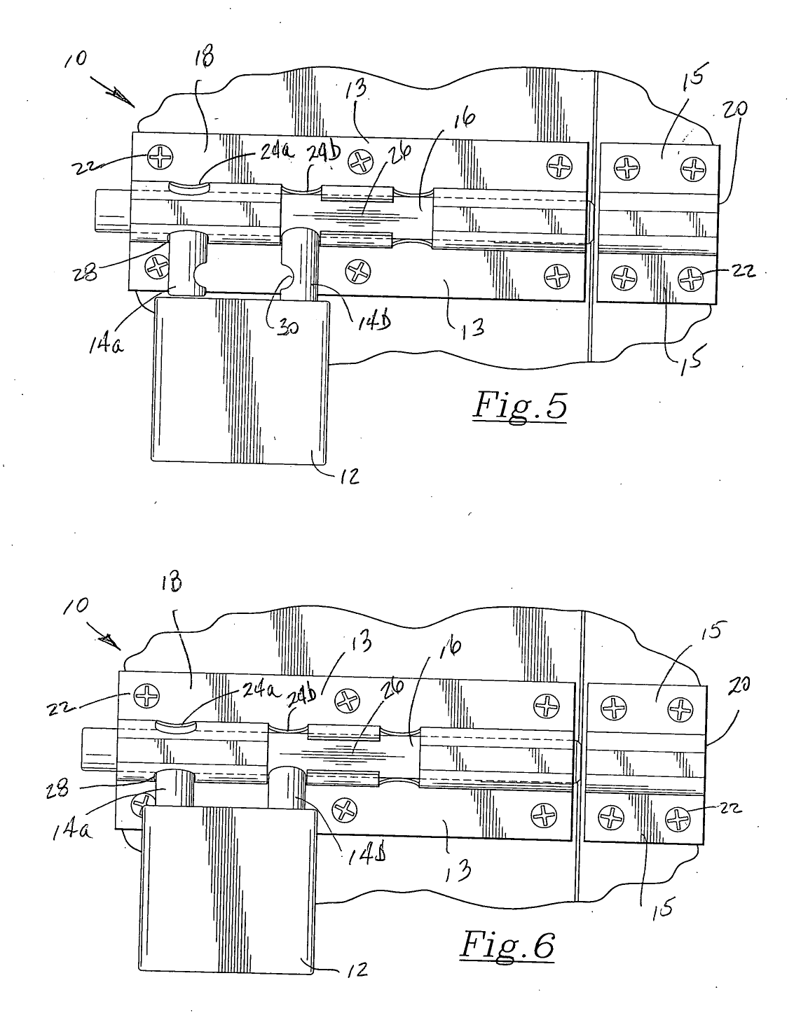

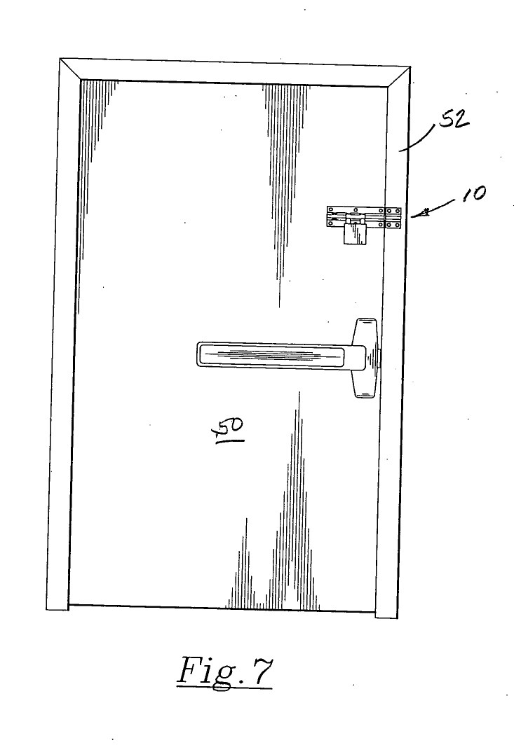

In the first embodiment of this invention, locking means 12 is swung outward and away from slide bolt 16 substantially perpendicular to the plane of the mounted locking device 10 such that locking pin 14b can move through the H-shaped aperture 26, facilitating the lateral sliding of shaft 16 out of and away from the slide bolt keeper 20. See FIG. 3 that shows the locking means 12 in the unlocked position and rotated away from the barrel housing 18, but with the locking device 10 still engaged within the keeper 20. With reference to FIG. 5, this view shows the slide bolt 16 slidably moved leftward so that locking pin 14a can engage the apertures 24a, 28. In FIG. 6, the locking device 10 is shown with locking pins 14a, 14b in the locked position along the slide bolt 16, but with the movable shaft 16 in the disengaged position, withdrawn from the slide bolt keeper 20. Locking pin 14a is located within the second aperture 28 of the barrel housing 18, as well as in aperture 24a of slide bolt 16. Locking pin 14b is now located on the other, or left, side of the H-shaped aperture 26 and the notch 30 is reengaged within locking means 20.

In a second embodiment of the present invention, locking pin 14a also has a notch 32 and can be removed from locking device 12. The locking pin 14a can be repositioned into the aperture 28 of slide bolt 16 in order to reengage the locking device 12 with notch 32 located along the body of locking pin 14a. FIG. 4 shows locking pin 14a being relocated from the left side of locking means 12 into the second aperture 28 of the barrel housing 18 as well as into the aperture 24a of the movable shaft 16. The locking pin 14a is shown as not yet engaged with the locking means 12 until the locking means 12 is reengaged with the notches 30, 32 of both locking pins 14a, 14b as shown in FIG. 6.

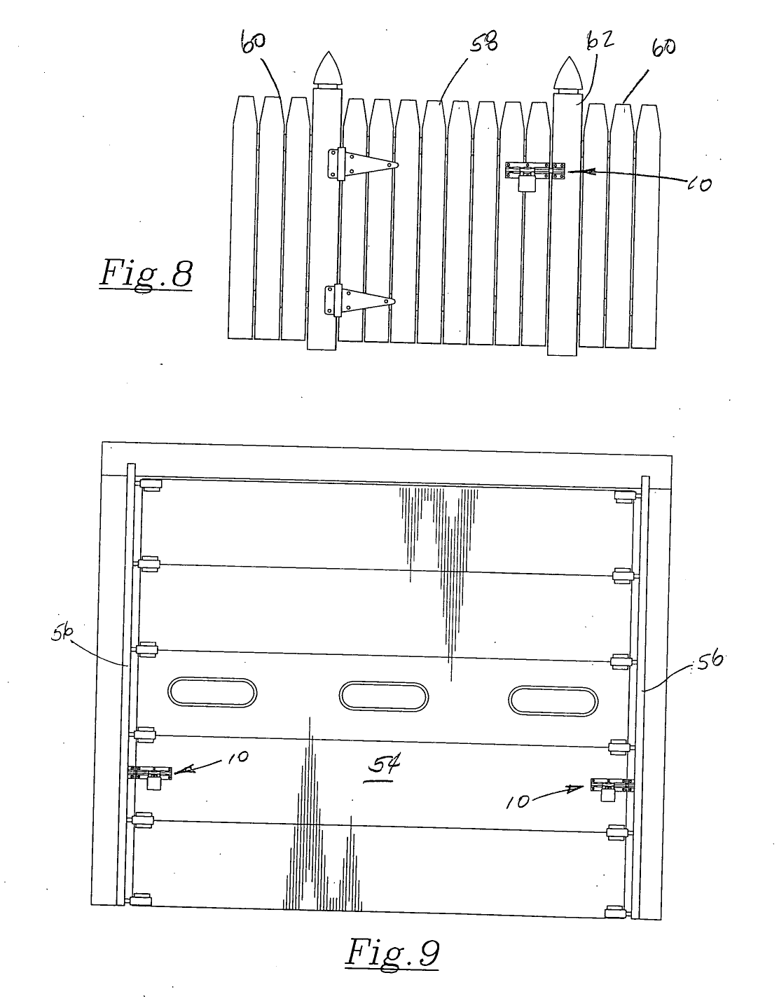

With the operation and structural configuration of the present invention described above, FIG. 7 shows the invention mounted on an exterior door 50 with a doorjamb 52. The locking device 10 is mounted across the space between the door 50 and the doorjamb 52 such that the flanges 13 of barrel housing 18 are mounted to the door 50 and the flanges 15 of slide bolt keeper 20 are mounted to the doorjamb 52. In this manner the slide bolt 16 may be withdrawn from and reinserted into the keeper 20 to unlock and relock the door 50. Similarly, in FIG. 9, there is shown a pair of the locking devices 10 of the present invention used to secure an overhead door 54 having door rail structures 56. The door rails 56 are used to mount the slide bolt keeper 20 and the overhead door receives the barrel housings 18 so that the slide bolt 16 can operate to engage and lock, or be withdrawn and unlock, the door 54 when the two parts of the locking device 10 are aligned for sliding engagement.

Finally, FIG. 8 shows the locking device 10 of the present invention mounted a gate 58 to an enclosure fence 60. The locking device spans the gap between the gate 58 and the opposing gatepost 62 with the flanges 13 of barrel housing 18 mounted to the gate 58 and the flanges 15 of slide bolt keeper 20 mounted to the gatepost 62. With the slide bolt aperture of both the barrel housing 18 and the keeper 20 aligned, the slide bolt 16 can operate to engage and lock, or be withdrawn and unlock, the gate 58 when the two parts of the locking device 10 are aligned for sliding engagement.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A locking device comprising:
a slide bolt having a barrel housing capable of retaining and permitting both rotational and lateral motion of said slide bolt into and out of engagement with a slide bolt keeper;
means for attaching the barrel housing to a structure and for attaching the slide bolt keeper to a juxtaposed structure on either side of an entryway space, each in coaxial alignment with the other;
a locking means with a first locking pin integrally being part of the slide bolt and a second locking pin to engage and disengage directly into said slide bolt shaft and through the barrel housing while the shaft is engaged with the slide bolt keeper and to engage and disengage directly into said shaft and through the barrel housing while the shaft is disengaged from the slide bolt keeper;
two apertures in the barrel housing to accommodate the second locking pin of the locking means to engage and disengage directly into said slide bolt shaft;
an aperture in said barrel housing to accommodate the lateral movement of the slide bolt with the first locking pin of the locking means engaged and integrally part of said slide bolt shaft.

2. A locking device for locking a movable structure against movement relative to a fixed structure, the device comprising:
a slide bolt having a barrel housing capable of retaining and permitting both rotational and lateral motion of said slide bolt into and out of engagement with a slide bolt keeper;
means for attaching the barrel housing to a structure and for attaching the slide bolt keeper to a juxtaposed structure on either side of an entryway space, each in coaxial alignment with the other;
a locking means with a first locking pin integrally being part of the slide bolt and a second locking pin to engage and disengage directly into said slide bolt shaft and through the barrel housing while the shaft is engaged with the slide bolt keeper and to engage and disengage directly into said shaft and through the barrel housing while the shaft is disengaged from the slide bolt keeper;
two apertures in the barrel housing to accommodate the second locking pin of the locking means to engage and disengage directly into said slide bolt shaft;
an aperture in said barrel housing to accommodate the lateral movement of the slide bolt with the first locking pin of the locking means engaged and integrally part of said slide bolt shaft.

3. The locking device of claim 1, wherein the locking means comprises:
a body for housing a locking mechanism;
means to secure a first end of a first locking pin in the locking mechanism while the second end of the first locking pin is permanently attached to the slide bolt shaft;
means to secure a first end of a second locking pin in the locking mechanism while the second end of the second locking pin is temporarily positioned through the barrel housing and into the slide bolt shaft;
wherein said first locking pin is movable through an H-shaped aperture in the barrel housing, and said second locking pin can engage and disengage from the barrel housing and slide bolt shaft so that the movable slide bolt shaft can shift laterally to engage with and disengage from the slide bolt keeper.

4. The locking device of claim 2, wherein locking means comprises:
a body for housing a locking mechanism;
means to secure a first end of a first locking pin in the locking mechanism while the second end of the first locking pin is permanently attached to the slide bolt shaft;
means to secure a first end of a second locking pin in the locking mechanism while the second end of the second locking pin is temporarily attached through the barrel housing and the slide bolt shaft;
wherein said first locking pin is movable through an H-shaped aperture in the barrel housing, and said second locking pin can engage and disengage from the barrel housing and slide bolt shaft so that the movable slide bolt shaft can shift laterally to engage with and disengage from the slide bolt keeper.

5. The locking device of claim 1, wherein the device is mounted to a moveable gate and juxtaposed fence structure.

6. The locking device of claim 1, wherein the device is mounted on a door and jam structure.

7. The locking device of claim 1, wherein the device is mounted to an overhead door system at two points on a door and on juxtaposed door rail structure.

8. The locking device of claim 1, wherein at least one device is mounted to an overhead door system at a point on a door and on a juxtaposed door rail structure.

9. The locking device of claim 1, wherein the means for attaching the barrel housing to a structure comprises two outwardly extending flanges substantially parallel to a structure surface; the flanges having apertures for fasteners to be attached through to the structure surface behind the locking device, and wherein the means for attaching the slide bolt keeper to a structure comprises two outwardly extending flanges substantially parallel to a structure surface; the flanges having apertures for fasteners to be attached through to the structure surface behind the locking device

10. The locking device of claim 2, wherein the means for attaching the barrel housing to a structure comprises two outwardly extending flanges substantially parallel to a structure surface; the flanges having apertures for fasteners to be attached through to the structure surface behind the locking device, and wherein the means for attaching the slide bolt keeper to a structure comprises two outwardly extending flanges substantially parallel to a structure surface; the flanges having apertures for fasteners to be attached through to the structure surface behind the locking device.

11. The locking device of claim 2, wherein the device is mounted to a moveable gate and juxtaposed fence structure.

12. The locking device of claim 2, wherein the device is mounted on a door and jam structure.

13. The locking device of claim 2, wherein the device is mounted to an overhead door system at two points on a door and on juxtaposed door rail structure.

14. The locking device of claim 2, wherein at least one device is mounted to an overhead door system at a point on a door and on a juxtaposed door rail structure.
